(19) United States
(12) Patent Application Publication
(10) Pub. No.: US 2006/0174633 A1
(43) Pub. Date: Aug. 10, 2006

(54) Thermoelectric pump assembly

(76) Inventor: Daniel Vem Beckley, Fenton, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 10/547,036

(22) PCT Filed: Feb. 23, 2004
(86) PCT No.: PCT/US04/05388

§ 371 Date: Aug. 26, 2005

(30) Foreign Application Priority Data
Feb. 27, 2003 (US) 60450435

(51) Int. Cl. F25B 21/02; B60H 1/32

(52) U.S. Cl. 62/3.3; 62/3.61; 62/239

(57) ABSTRACT

A thermoelectric pump assembly (10) includes at least one thermoelectric device (12) that changes a temperature of a vehicular structure (16) when electric current is directed through the thermoelectric device (12). Ambient air is drawn across the vehicular structure (16) into a central air duct cavity (26) of a heating and cooling system (20) for heating or cooling of a vehicle.

### TECHNICAL FIELD

The present invention relates to structural components of a vehicle, and in particular to a thermoelectric pump assembly that changes a temperature of a structural component of a vehicle when electric current is directed through a thermoelectric device in thermal communication with the structural component.

### BACKGROUND OF THE INVENTION

Thermoelectric principles that are the basis for today's thermoelectric industry were first discovered by early 19th century scientists Thomas Seebeck and Jean Peltier. Thomas Seebeck found that if a temperature gradient is placed across the junctions of two dissimilar conductors, an electrical current would flow. Jean Peltier, on the other hand, discovered “the Peltier effect.” The Peltier effect occurs when electric current is passed through two dissimilar electrical conductors so as to cause heat emission or absorption at the junction of the two dissimilar conductors.

It was only after mid-20th Century advancements in semiconductor technology, however, that practical applications for the Peltier effect permitted the manufacturing of thermoelectric modules. The semiconductors material of choice for producing the Peltier effect is typically Bismuth Telluride. Bismuth Telluride is commonly chosen due to its easily optimized heat pumping capabilities. In addition to optimized heat pumping capabilities, Bismuth Telluride's charge carriers can be easily controlled by thermoelectric module designers. Thus, Bismuth Telluride, or any other suitable semiconductor material, may be used by a designer to manufacture a thermoelectric module by soldering electrically conductive material, such as plated copper, to a top surface and bottom surface of the semiconductor material. The second dissimilar material required for the Peltier effect includes copper connection leads that extend from a power supply.

As seen in FIGS. 1 and 2, heat is moved (i.e. pumped) by a circuit 1, 2 generally in the direction of the arrow, H, depending on the direction of the charge carrier movement through the circuit 1, 2. Each circuit 1, 2 includes an upper copper plate 3, a lower copper plate 4, and an N-type semiconductor material 5a (FIG. 1) or a P-type semiconductor material 5b (FIG. 2). Referring initially to FIG. 1, a clockwise arrow, A, illustrates how electrons with a negative charge, employs the charge carrier movement to create the bulk of the Peltier effect. When a DC voltage source, V_{DC}, is connected to the circuit 1 as shown, electrons will be repelled by the negative pole and attracted by the positive pole of the supply, V_{DC}, which forces the electron flow in the clockwise direction of the arrow, A. As a result, because the electrons flow through the N-type semiconductor material 5a from lower copper plate 4 to the upper copper plate 3, the heat, H, is absorbed at a lower junction 6 of the circuit 1 and then actively transferred to a top junction 7 of the circuit 1 by charge carriers moving through the semiconductor material 5a.

As shown in FIG. 2, the P-type semiconductor material 5b is manufactured so that the charge carriers are positive, which are known in electronics as ‘holes.’ The holes enhance the electrical conductivity of the P-type crystaline structure of the semiconductor material 5b, thereby allowing electrons to flow more freely through the material when a voltage is applied. Once the voltage is applied from the source, V_{DC}, as shown, positive charge carriers are repelled by the positive pole of the DC supply and attracted to the negative pole. As a result, the ‘hole’ current flows in a direction opposite to that of electron flow, which is generally illustrated by the counter-clockwise arrow, B. Because the charge carriers inherent in the P-type semiconductor material 5b convey the heat through the conductor, use of the P-type semiconductor material 5b results in the heat, H, being drawn toward the negative pole of the power supply, V_{DC}, and away from the positive pole.

As illustrated in FIGS. 3 and 4, N-type and P-type semiconductor pellets 5a, 5b may be arranged in a ‘couple,’ such that a junction is formed at an upper copper plate 3. Upper and lower ceramic plates 9a, 9b isolate a series circuit 11 including the couple, which is hereinafter referred to as a thermoelectric module 11. Based on the principles discussed above, the thermoelectric module 11 applies heat, H, to an object 8a (FIG. 3), or, alternatively, the thermoelectric module 11 removes heat, H, from the object 8a, which is subsequently transferred to a heat sink 8b (FIG. 4). More specifically, in relation to FIG. 3, the lower copper plate 4b of the P-type semiconductor pellet 5b is connected to the positive voltage potential of the source, V_{DC}, and the lower copper plate 4a of the N-type semiconductor pellet 5a is similarly connected to the negative side of the source, V_{DC}. As a result, the positive charge carriers (i.e, ‘holes’) in the P-type semiconductor material 5b are repelled by the positive voltage potential and attracted by the negative pole; concurrently, the negative charge carriers (i.e. electrons) in the N-type semiconductor material 5a are repelled by the negative potential and attracted by the positive pole of the supply, V_{DC}. Thus, heat, H is applied from the thermoelectric module 11 to the object 8a. Conversely, when the polarity of the supply, V_{DC}, is reversed (FIG. 4), heat, H, is removed from the object 8a by the thermoelectric module 11, which is then released by the heat sink 8b. However, the heat sink 8b of a conventional thermoelectric module 11 occupies valuable real estate when used in an automotive application.

### SUMMARY OF THE INVENTION

The invention comprises a thermoelectric pump assembly. The thermoelectric pump assembly includes a vehicular structure and a thermoelectric pump device in thermal communication with the vehicle structure, wherein the thermoelectric device changes a temperature of the vehicular structure when electric current is directed through the thermoelectric device.

A method for manufacturing a thermoelectric pump assembly is also disclosed. The method includes the steps of arranging at least one thermoelectric module on a heat sink surface to form a thermoelectric device, securing the thermoelectric device to a vehicular structure such that the thermoelectric device is in thermal communication with the vehicle structure, arranging a heat sink duct over the thermoelectric device, and securing the heat sink duct to the vehicular structure.

### BRIEF DESCRIPTION OF THE DRAWINGS

The present invention will now be described, by way of example, with reference to the accompanying drawings, in which:

FIG. 1 illustrates a conventional N-type thermoelectric circuit;

FIG. 2 illustrates a conventional P-type thermoelectric circuit;

FIG. 3 illustrates a conventional thermoelectric module and a power supply having a first polarity;

FIG. 4 illustrates another embodiment of the conventional thermoelectric module with the power supply having a second reversed polarity as that of FIG. 3;

FIG. 5 is a passenger compartment view of a thermoelectric pump assembly with the dashboard trim panel removed for clarity according to one embodiment of the present invention;

FIG. 6 is a perspective view of a thermoelectric device including a plurality of thermoelectric modules according to one embodiment of the present invention; and

FIG. 7 is a cross-sectional view of the thermoelectric pump assembly taken along line 7-7 of FIG. 5.

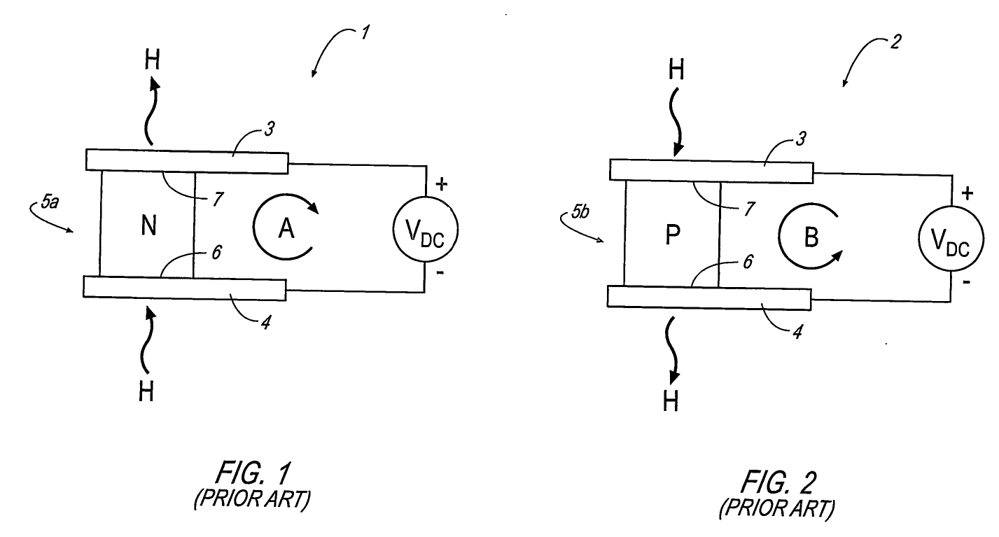

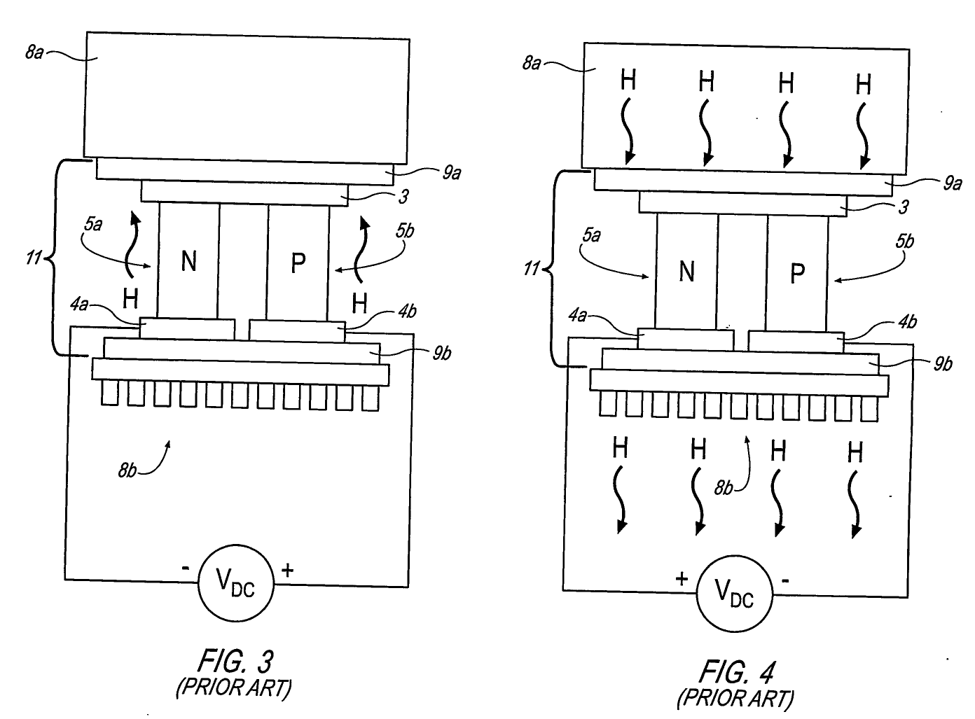

### DESCRIPTION OF THE PREFERRED EMBODIMENT

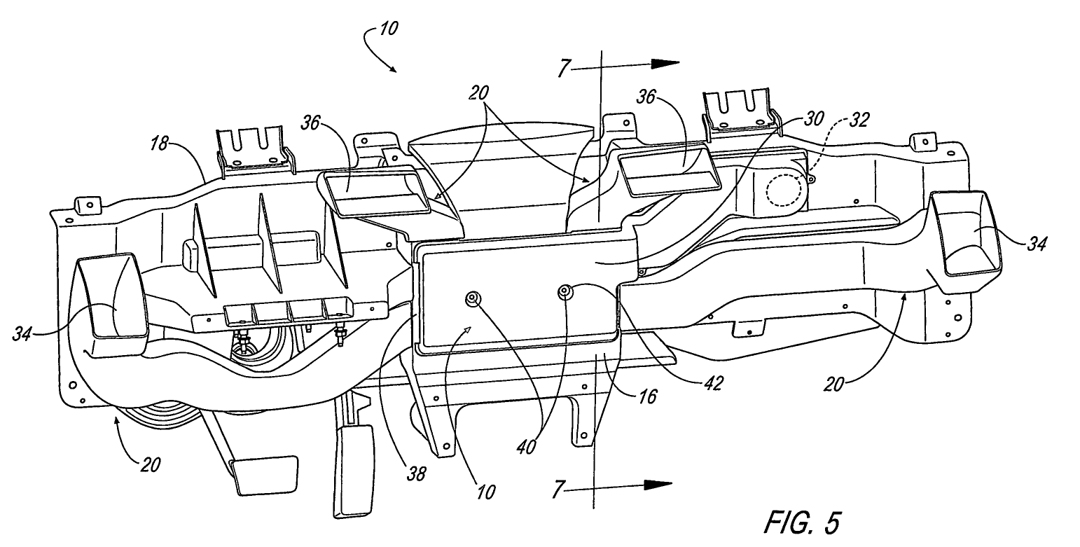

As illustrated in FIGS. 5-7, a thermoelectric pump assembly, designated at 10, is shown according to an embodiment of the invention. In general, thermoelectric pump assembly 10 includes a thermoelectric device 12 comprising at least one thermoelectric module 14 affixed to a vehicular structure 16 via a mechanical bond (e.g. by fastening or form-pressing), a chemical bond (i.e. with a thermal adhesive), or the like. The vehicular structure 16 may comprise, for example, a cross-car instrument panel (I/P) beam 18 and a heating and cooling system 20. Each thermoelectric module 14 substantially operates on the same principle relating to the Peltier effect as described above in relation to FIGS. 3 and 4. It should be noted that heat generation or absorption rates at the junction of each thermoelectric module 14 are proportional to the magnitude of the electric current and temperature of the junction.

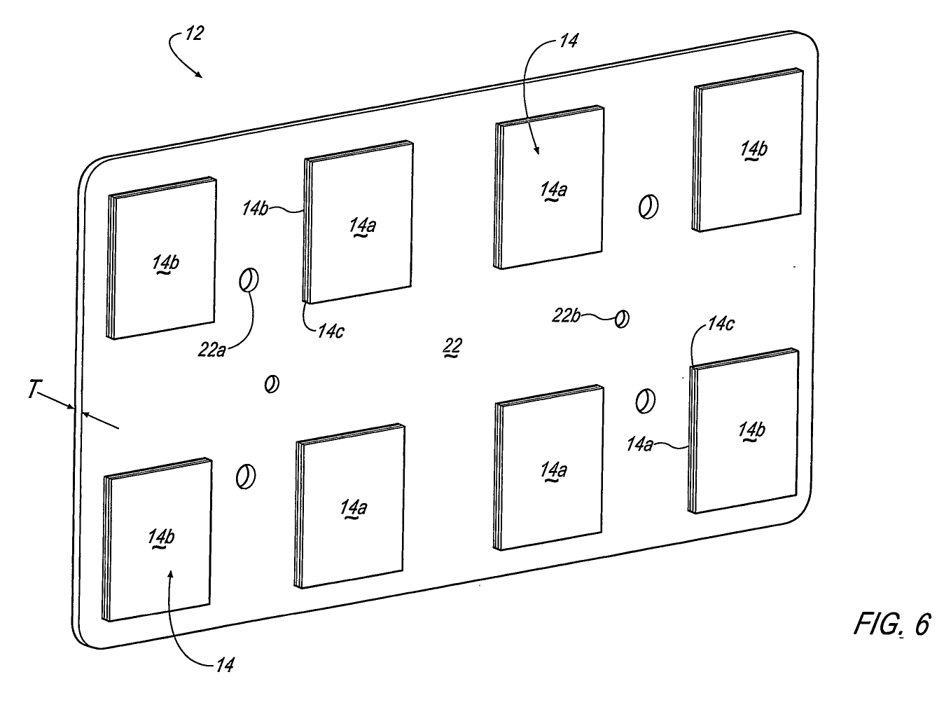

As seen in FIG. 6, each thermoelectric module 14 includes a pair of ceramic plates, which are designated at layers 14a, 14b, and a plurality of N-type and P-type semiconductor couples sandwiched by upper and lower copper plates, which is designated generally at layer 14c. As illustrated, one of the layers 14a, 14b is adjacently affixed, via a mechanical or chemical bond, to a heat sink surface 22, having a thickness, T, which may also be referred to as a ‘cooling plate.’ The heat sink surface 22, which may include a plurality of fastener passages 22a, 22b (if mechanical fastening to vehicle structure 16 is implemented), is preferably composed of a material that has a high thermal conductivity that dissipates heat quickly, such as magnesium, aluminum, copper, or the like. The thermoelectric device 12 is shown to include eight thermoelectric modules 14 disposed in a two-by-four column and row arrangement on the heat sink surface 22. However, any desirable configuration, such as a square, circle, triangle, or any other uniform or non-uniform configuration of thermoelectric modules 14 on the heat sink surface 22 may be implemented. Additionally, the polarity of a power supply (not shown) connected to each thermoelectric module 14 may be referenced according to the layer 14a, 14b that is affixed to the heat sink surface 22. If desired, one or all of the thermoelectric modules 14 may be activated at any given time.

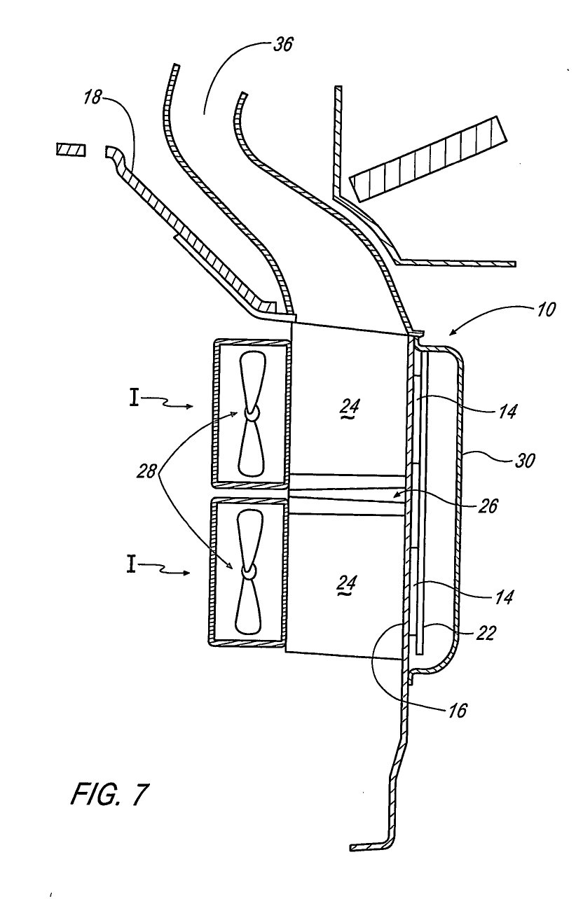

In reference to FIG. 7, the thermoelectric modules 14 are intermediately located between the heat sink surface 22 and the vehicle structure 16. In accordance with the principles of the Peltier effect, when an electrical current is passed through the thermoelectric modules 14 in a specific direction, the vehicular structure 16, may be heated or cooled. According to the illustrated embodiment of the invention, the thermoelectric modules 14 operate on the heating and cooling system 20 portion of the vehicle structure 16, which includes a plurality of fins 24 disposed within a central air duct cavity 26. Because the fins 24 are generally positioned within (i.e. positioned in-line) and interface with the central air duct cavity 26, which is located proximate a plurality of fans 28, the fins 24 may be used as a heating or cooling element for the heating and cooling system 20 to treat ambient air, depending on the direction of the electrical current flowing through the thermoelectric modules 14. In operation, the fans 28 draw the ambient air into the heating and cooling system 20 about an air flow intake path, I, across the fins 24 so as to heat or cool the ambient air which is subsequently circulated though a plurality of passenger compartment ducts, such as, for example, front passenger compartment ductwork 34 (FIG. 5), winter defroster ductwork 36, or the like.

As seen in FIG. 5, the thermoelectric pump assembly 10 further comprises a heat sink duct 30 that may be fastened to the vehicle structure 16 by a plurality of fasteners 40, such as screws or bolts, extending through duct bores 42 of the heat sink duct 30. Although not shown in FIG. 5, the fasteners 40 extend through the heat sink fastener passages 22b to mechanically engage the heat sink surface 22. In an alternative embodiment, the heat sink duct 30 may be held in place or fastened by at least one clamp or peripheral lip, which is shown generally at reference numeral 38. Functionally, the heat sink duct 30 seals the thermoelectric device 12 from moisture ingress, contaminates, and the other components in the passenger compartment-side of the firewall, while also directing warm air from the heat sink surface 22 to the engine compartment through an instrument panel beam port, which is shown in phantom at reference numeral 32. In an alternative embodiment, the heat sink duct 30 may direct the warm air from the heat sink surface 22 outside the vehicle to a driver- or passenger-side through the vehicle body sheet-metal (not shown).

As a result of including the thermoelectric pump assembly 10 in an automotive assembly, heater cores of a conventional heating and cooling system may be eliminated entirely. Additionally, if the fins 24 are used as a heating element, heat may be instantaneously provided by the heating and cooling system 20 in a situation when the vehicle's engine is cold-started such that heat is not available upon keying the ignition. Thus, the thickness, T, of the heat sink surface 22 may be designed accordingly to provide adequate material volume for a cooling or heating operation. Although the thermoelectric device 12 is shown as a component of the heating and cooling system 20, the thermoelectric device 12 may be applied to any vehicle application, such as, for example, a vehicular refrigerator (i.e. beverage cooler), a heat sink for other electronics, such as, for example, a radio/compact disc player, or the like.

It should be understood that the aforementioned and other various alternatives to the embodiments of the invention described herein may be employed in practicing the invention. It is intended that the following claims define the scope of the invention and that the method and apparatus within the scope of these claims and their equivalents be covered thereby.

1.-17. (canceled)

18. A thermoelectric pump assembly comprising:
a heat sink surface;
a load-bearing vehicular structure adjacent to said heat sink surface and arranged to define a cavity therebetween,
at least one thermoelectric module having opposing sides disposed in said cavity, one of said sides connected to said heat sink surface the other one of said sides connected to said load-bearing vehicular structure that acts as a heatsink when electric current is directed through the thermoelectric module.

19. The thermoelectric pump assembly according to claim 18, wherein said load-bearing vehicular structure is selected from the group consisting of a vehicle frame, a beam, a support, and the vehicle body.

20. The thermoelectric pump assembly according to claim 18, wherein the load-bearing vehicular structure includes a plurality of fins positioned in thermal communication with a central air duct cavity of a heating and cooling system and the thermoelectric pump assembly.

21. The thermoelectric pump assembly according to claim 20, wherein the heating and cooling system includes at least one fan that draws ambient air about an intake path through the central air duct cavity and across the plurality of fins.

22. The thermoelectric pump assembly according to claim 18, wherein the thermoelectric module is affixed to the load-bearing vehicle structure by a plurality of fasteners that extend through fastener passages of the heat sink surface to mechanically engage the vehicular structure.

23. The thermoelectric pump assembly according to claim 18, wherein the at least one thermoelectric module is arranged on the heat sink surface via a mechanical bond.

24. The thermoelectric pump assembly according to claim 18, wherein the thermoelectric pump assembly further comprises a heat sink duct affixed to the vehicular structure.

25. The thermoelectric pump assembly according to claim 24, wherein the heat sink duct is affixed to the vehicular structure by a plurality of fasteners that extend through duct bores of the heat sink duct.

26. The thermoelectric pump assembly according to claim 20, wherein the heat sink surface includes a plurality of fastener passages that permits passage and mechanical engagement of the fasteners with the air duct cavity.

27. The thermoelectric pump assembly according to claim 24, wherein the heat sink duct is affixed to the vehicular structure by at least one clamp or peripheral lip.

28. The thermoelectric pump assembly according to claim 24, wherein the heat sink duct is affixed over an instrument panel beam port to permit evacuation of warm air from the heat sink surface to the engine compartment.

29. The thermoelectric pump assembly according to claim 22, wherein heat sink surface is comprised of high thermal conductivity material selected from the group consisting of magnesium, aluminum, and copper.

30. A method of manufacturing a thermoelectric pump assembly, comprising the steps of:
arranging at least one thermoelectric module on a heat sink surface to form a thermoelectric device;
securing the thermoelectric device to a load-bearing vehicular structure such that the thermoelectric device is in thermal communication with the load-bearing vehicular structure;
arranging a heat sink duct over the thermoelectric device; and
securing the heat sink duct to the load-bearing vehicular structure.

31. The method according to claim 30, wherein securing the thermoelectric device further comprises the step of inserting fasteners through a plurality of fastener passage in the heat sink surface to mechanically engage the load-bearing vehicular structure.

32. The method according to claim 30, wherein securing the heat sink duct further comprises the step of inserting fasteners through a plurality of heat sink duct bores of a heat sink duct and fastener passages in the heat sink surface to mechanically engage the load-bearing vehicular structure.

33. The method according to claim 30, further comprising the steps of:
directing an electric current through the at least one thermoelectric module in a first direction to increase a temperature of the load-bearing vehicular structure or directing the electric current through the thermoelectric module in a second direction to decrease the temperature of the vehicle structure.

34. The method according to claim 30, further comprising the step of drawing ambient air across the vehicular structure.
